(19) United States
(12) Patent Application Publication
(10) Pub. No.: US 2012/0267560 A1
(43) Pub. Date: Oct. 25, 2012

(54) REPLACEABLE RELIEF VALVE FOR MULTIPLE CYLINDER / GAS APPLICATIONS

(75) Inventor: JAMES MICHAEL ROCKWOOD, North Tonawanda, NY (US)

(73) Assignee: TAYLOR-WHARTON INTERNATIONAL, LLC, Mechanicsburg, PA (US)

(21) Appl. No.: 13/091,166

(22) Filed: Apr. 21, 2011

(51) Int. Cl. F16K 27/00

(52) U.S. Cl. 251/336; 137/343

(57) ABSTRACT

A modular relief valve having an increased number of exhaust passages is provided. The modular configuration allows for the entire relief valve to be installed as a unit into the relief valve cavity on a service valve. The relief valve includes at least two exhaust passages. The additional passages allow a greater flow rate than traditional relief valves.

### BACKGROUND OF THE INVENTION

1. Field of the Invention

This application relates to a relief valve for a service valve for a pressurized gas cylinder and, more specifically, to a relief valve structured to allow a greater flow rate for use in multiple cylinder/gas applications than relief valves presently in use.

2. Background Information

Pressurized gas cylinders are well known and the population of pressurized gas cylinders in use in the United States is estimated to be about sixty million cylinders. A “family” of similar cylinders are structured, i.e. sized and designed to withstand a predetermined pressure, etc., to be used with a limited number of gasses stored at a pressure in a limited range. Cylinders within such a family have substantially similar characteristics; e.g. a similar radius and a similar coupling for a service valve. As such, the service valves for cylinders within a family must also be substantially similar, e.g. have a threaded neck structured to be coupled to any cylinder in the family. Thus, the service valves for a family of cylinders have similar dimensions as well.

The service valve includes a body and a valve assembly and may include a relief valve. The service valve body defines a primary fluid passage with a valve seat about the primary fluid passage, a primary exhaust passage, a valve assembly cavity, and a relief valve cavity. The primary fluid passage and the primary exhaust passage are in fluid communication via the valve assembly cavity. The valve assembly is disposed in the valve assembly cavity. The valve assembly has a valve member structured to move between two positions, a first, closed position, wherein the valve member sealingly engages the valve seat preventing fluid from passing past the valve member, and a second, open position, wherein the valve member is spaced from the valve seat allowing fluid communication between the primary fluid passage and the exhaust passage. The relief valve cavity is also a cylindrical cavity. The relief valve cavity has a first end with an opening in fluid communication with the primary fluid passage and a second end open to the atmosphere.

It is further noted that the components of the relief valve are typically built into, or structured to directly engage, the cavity. That is, a typical relief valve cavity includes a seat disposed about the first end opening, a valve member, a biasing device, and a retainer. The valve element is movably disposed adjacent the valve seat, the retainer is spaced from the valve member, and the biasing device, typically a spring, extends between the retainer and the valve member. The biasing device biases the valve member against the seat, thereby sealing the relief valve. If the pressure in the cylinder exceeds a selected pressure, the fluid pressure overcomes the bias of the biasing device and allows the valve member to move away from the seat thereby allowing the fluid to escape and lower the pressure in the cylinder. It is further noted that the retainer is typically threaded into the relief valve cavity. In this configuration, the strength of the biasing device may be adjusted by moving the retainer closer or farther from the valve member, thereby changing the compression on the biasing device.

The relief valve valve member is, typically, structured as a cap, i.e. a cylinder closed on one end. The bottom of the relief valve valve member is made from a resilient material structured to sealingly engage the relief valve valve seat. The body of the relief valve valve member is, typically, made from a material that is more rigid than the resilient material. The relief valve valve member has a radius slightly larger than the biasing device, i.e. the spring. In this configuration, the biasing device is trapped in the relief valve valve member and the pressure applied to the resilient member is, essentially, uniform. It is further noted that the retainer typically includes a single, central opening. The opening typically includes an axially, inwardly extending flange. This flange may be used as a mount for a circular spring. That is, one end of the spring is disposed about the flange with the other end disposed in the relief valve valve member cup-shape body. The size of the opening influences, or may limit, the flow rate through the relief valve.

Due to their varied vapor pressures, various liquefied gases are typically stored in cylinders structured for different service pressures. The relief valve is structured to open at a selected pressure range which is dependent on the cylinder service pressure. Thus, the relief pressure varies from gas to gas. For example, propane is typically stored in cylinders with a service pressure of 240 psi., whereas propylene is typically stored in cylinders with a service pressure of 260 psi. Accordingly, the relief pressure for propane cylinders is 360-480 psi and the relief pressure for propylene cylinders is 435-520 psi. Further, each type of cylinder configuration has a required minimum flow rate, at an associated pressure, at which the gas is intended to flow during relief of an over-pressure event. The required flow rate is dependent on cylinder size and the flow pressure is dependent on the cylinder service pressure. Thus, the relief valve is structured to start to open at a relief pressure, then fully flow at a higher pressure. Given that different types of liquefied gases use different cylinders, it would be useful to be able to have one valve that can be used for multiple cylinders, assuming the service valve is structured to operate with both types of fluid.

However, noting that different gases may react with different materials (e.g., the valve member material), and that different springs have different compression strengths, it is generally not advisable to remove the relief valve components from the relief valve cavity as users may “mix-and-match” components from different relief valves during reassembly. This means that, while relief valves may be disassembled, they are generally not intended to be used in this manner.

Further, because the population of pressurized gas cylinders in use is so large, and because the service valves have similar dimensions, the relief valve must be structured to fit within the existing service valves. That is, it is impractical to design a substantially new relief valve, e.g. having different dimensions, as such a new relief valve would require a new service valve which would not fit existing cylinders. This becomes a problem when the standard or regulated relief pressure and/or relief flow rate is changed. That is, because the population of cylinders and service valves is so large, it is impractical to replace all cylinders and service valves to accommodate a relief valve having a new design created to accommodate a new relief pressure regulation.

Recently, the regulations relating to the relief pressure and relief flow rate for propylene have required an increased relief pressure. Thus, there is a problem of adapting relief valves to provide a desired flow rate for a relief valve in a configuration that may be used for multiple gasses and cylinder configurations. There is a further problem in that replacement of relief valves should not be a separate component that may be accidentally mixed-and-matched thereby allowing non-matching components to be used together.

### SUMMARY OF THE INVENTION

The disclosed and claimed concept relates to a modular relief valve having an increased number of exhaust passages. The modular configuration allows for the entire relief valve to be installed as a unit, whereby there is a reduced chance that components of different valves will be comingled. It is noted that the modular nature of the valve is accomplished, in part, by providing a cylindrical body that is disposed in the service valve's relief valve cavity. This relief valve body occupies space and reduces the space available for the biasing device, i.e. the compression spring. As the compression spring has a reduced radius, the mount on the retaining member also has a reduced radius, and therefore the opening through the retaining member has a reduced, or limited, radius. Thus, the size of the exhaust passage from the relief valve is reduced, meaning that the exhaust flow rate is either reduced, or must be at an increased pressure to maintain the required flow rate.

This problem, however, is addressed, by providing multiple exhaust passages for the relief valve. Again, the stated problem is that, given the limitation on the size of the relief valve (because the relief valve must be operable with the present population of cylinder configurations), the relief valve may not simply be enlarged. Further, solutions such as increasing the size of the opening are not practical as an increase in the size of the opening would mean that the inwardly extending flange (the mount for the relief valve spring) would increase. If the radius of the flange increases, the radius of the spring must increase. As relief valve springs typically extend to the perimeter of the relieve valve cavity, the requirement for a larger spring means that the size of the relief valve cavity must increase. That is, typically there is no additional room in the relief valve cavity for a spring with a larger radius, meaning that a larger spring requires a larger relief valve body, which would not fit in the service valve.

Put another way, the stated problem is that known valve configurations do not achieve the desired flow rate while being sized to fit within the relief valve cavity on the population of existing service valves. The disclosed and claimed concept addresses this problem by providing a retaining member having an elongated body with two opposing parallel sides and two opposing arcuate ends. The arcuate ends are structured to engage threads on the inner surface of the relief valve body. The two parallel sides do not engage the threads on the relief valve body. That is, because the relief valve body is cylindrical, the shape of the retainer creates gaps between the relief valve body and the two parallel sides. These gaps allow for an increased flow rate through the relief valve even though the modular relief valve occupies more space in the service valve's relief valve cavity that a non-modular configuration relief valve.

### BRIEF DESCRIPTION OF THE DRAWINGS

A full understanding of the invention can be gained from the following description of the preferred embodiments when read in conjunction with the accompanying drawings in which:

FIG. 1 is cross-sectional side view of a service valve.

FIG. 2 is a cross-sectional view of a relief valve.

FIG. 3 is a top view of a retaining member.

FIG. 4 is s cross-sectional side view of the retaining member.

FIG. 5 is an end view of the relief valve.

FIG. 6 is an end view of an alternate embodiment of the relief valve.

FIG. 7 is an end view of an alternate embodiment of the relief valve.

### DESCRIPTION OF THE PREFERRED EMBODIMENTS

As used herein, a “modular” component is one having multiple elements configured as a single unit. For example, reel-to-reel magnetic tapes are not “modular,” but cassette tapes are “modular.”

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other. The fixed components may, or may not, be directly coupled.

As used herein, the word “unitary” means a component is created as a single piece or unit. That is, a component that includes pieces that are created separately and then coupled together as a unit is not a “unitary” component or body.

As used herein, “opposing” when used to describe relative locations of elements on the retainer means located on opposite sides of the center of the retainer body.

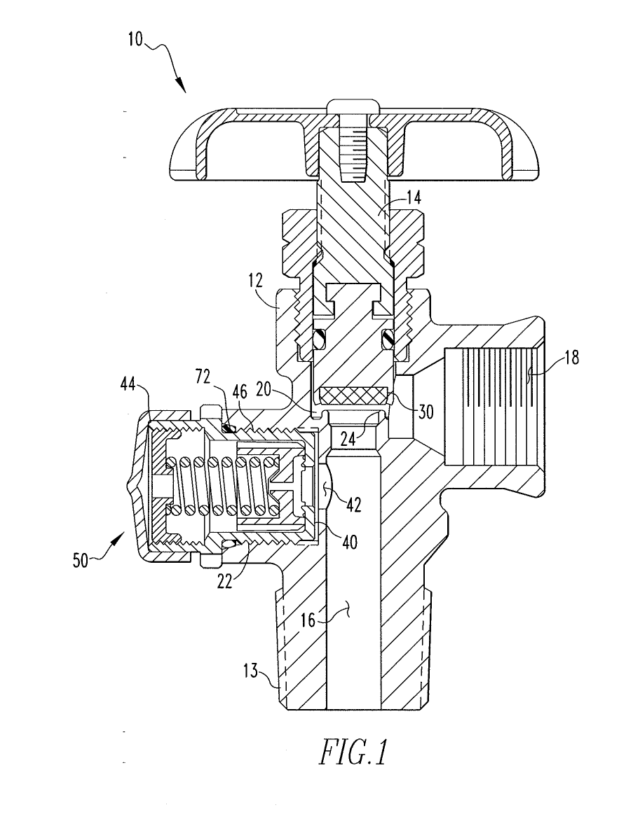

As shown in FIG. 1, a service valve 10 for a storage cylinder (not shown) includes a body 12 and a valve assembly 14. The service valve body 12 has a lower end 13 having a threaded, circular portion structured to be coupled to, and sealingly engage, a storage cylinder. The service valve body 12 defines a primary fluid passage 16, a primary exhaust passage 18, a valve assembly cavity 20, and a relief valve cavity 22. The primary fluid passage 16 extends from an opening in the service valve body lower end 13 to the valve assembly cavity 20. A valve seat 24 extends about the primary fluid passage 16 within the valve assembly cavity 20. The primary exhaust passage 18 is in fluid communication with the valve assembly cavity 20 as well. Thus, the primary fluid passage 16 and the primary exhaust passage 18 are in fluid communication via the valve assembly cavity 20 unless blocked by the valve member 30, described below. The valve assembly 14 is disposed in the valve assembly cavity 20. The valve assembly 14 includes a valve member 30 structured to move between two positions, a first, closed position, wherein the valve member 30 sealingly engages the valve seat 24 preventing fluid from passing the valve member 30, and a second, open position, wherein the valve member 30 is spaced from the valve seat 24 allowing fluid communication between the primary fluid passage 16 and the exhaust passage 18. The mechanics of the valve assembly 14 are not relevant to this disclosure, but, as is known in the art, there may be a threaded stem coupled to a portion of the valve assembly cavity 20 with internal threads. The stem is structured to move between a lower position and an upper position, the stem further being coupled to the valve member 24 and having a plurality of seals disposed thereabout.

The relief valve cavity 22 is a cylindrical cavity having a first end 40 with an opening 42 in fluid communication with the primary fluid passage 16, and, a second end 44 open to the atmosphere. The relief valve cavity 22 has a threaded interior surface 46. That is, a portion, and preferably a substantial portion, of the relief valve cavity 22 interior surface is threaded.

A modular relief valve 50 is structured to be disposed in the relief valve cavity 22. As shown in FIG. 2, the modular relief valve 50 includes a body 52, a valve member 54, a biasing device 56, and a retainer 58. The relief valve body 52 is a hollow, generally cylindrical body having a first end 60, a second end 62, an outer surface 64 and an inner surface 66. The relief valve body defines a relief valve body cavity 68. The relief valve body outer surface 64 has threads 70 thereon. The relief valve body outer threads 70 are structured to engage the relief valve cavity 22 threaded interior surface 46. There is also at least one seal 72 disposed about the relief valve body outer surface 64 structured to sealingly engage both the relief valve body 52 and the relief valve cavity 22 when the relief valve body 52 is threaded into the relief valve cavity 22. The relief valve body first end 60 has an inwardly extending flange 74 with a central opening 76. The flange 74 defines a valve seat 78, which preferably includes a raised rim extending about the interior side of the central opening 76. The relief valve body second end 62 has interior threads 80.

The relief valve valve member 54 is made from a resilient material and is structured to sealingly engage the relief valve body valve seat 78. Preferably, the relief valve valve member 54 includes a cup-like body 53 and a resilient disk 55. The resilient disk 55 is disposed on the outer, bottom side of the cup-like body 53 and is structured to sealingly engage the relief valve body valve seat 78. The cup-like body 53 open end faces the retainer 58. The relief valve valve member 54 is further structured to be movably disposed in the relief valve body cavity 68.

The biasing device 56 is structured to engage the relief valve valve member 54 and bias the relief valve valve member 54 against the relief valve body valve seat 78. The biasing device 56 is, preferably, a coiled compression spring 57. The retainer 58, described in detail below, is structured to be threaded into the relief valve body second end 62 and extend there across. The biasing device 56 is coupled to, and compressed between, the retainer 58 and the relief valve valve member 54. In this configuration, the biasing device 56 causes the relief valve valve member 54 to be sealed against the relief valve body valve seat 78 until a pressure greater than the biasing force overcomes the force of the biasing device 56.

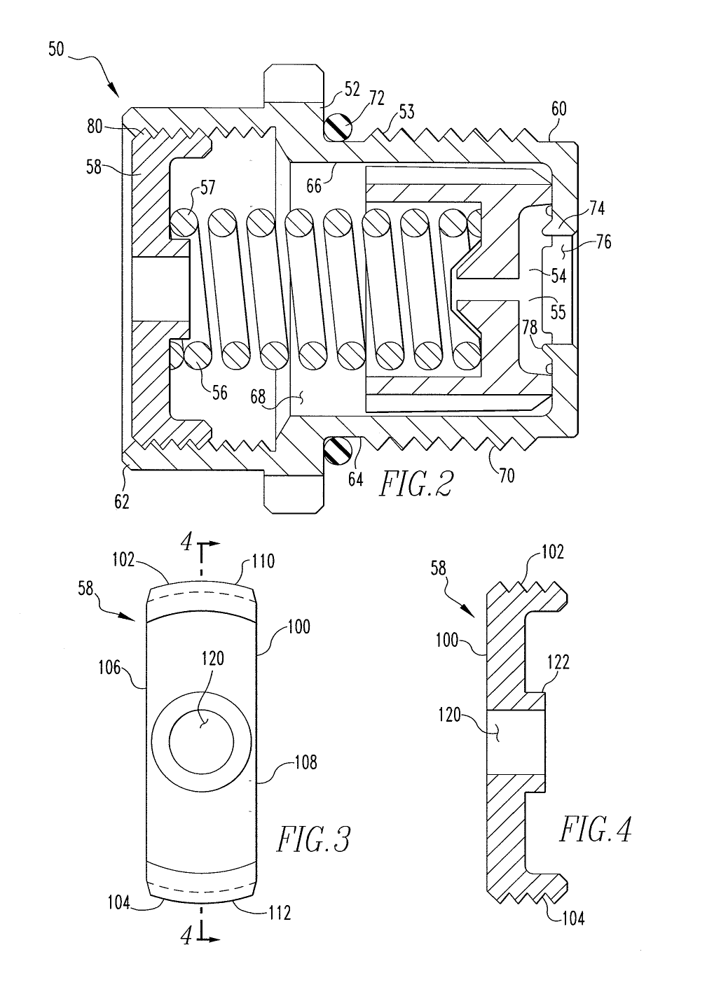

Because the retainer 58 is disposed at the end of the relief valve body second end 62, which is typically open to the atmosphere, the size of the retainer 58 determines the size of the relief exhaust passage 90. As shown in FIGS. 3-5, the retainer 58 disclosed herein is structured to define at least two exhaust passages 90A, 90B, and preferably, a third relief exhaust passage 90C. Moreover, only one exhaust passage is defined exclusively by the retainer body 100.

That is, the retainer 58 has a generally planar body 100 with a first perimeter portion 102 and a second perimeter portion 104. Preferably, the retainer body 100 is elongated and has two opposing, generally straight parallel sides 106, 108. Further, the first perimeter portion 102 and the second perimeter portion 104 are preferably two opposing threaded radial surfaces 110, 112. The radial, i.e. lateral, surface of the two opposing threaded radial surfaces 110, 112 are threaded and are structured to engage the relief valve body second end interior threads 80. In this configuration, and when the retainer 58 is coupled to the circular relief valve body second end 62, the gaps between the circular relief valve body second end 62 and the retainer body opposing parallel sides 106, 108 define two relief exhaust passages 90A, 90B. Further, the retainer body 100 may define an opening 120 that acts as another relief exhaust passage 90C. As is known, the retainer body 100 may further include an inwardly extending flange 122 about the retainer body opening 120 that is structured to be a mount for the biasing device 56. That is, one end of the coiled compression spring 57 may be disposed about the retainer body flange 122. It is noted that, alternatively, the retainer body 100 may include a single straight, longitudinal side 106 and the body opening 120. In this configuration, the longitudinal side 106 and the circular relief valve body second end 62 form a gap which is a relief exhaust passage 90A and the retainer body opening 120 acts as the other relief exhaust passage 90C. In either configuration, the additional relief exhaust passage 90 provides sufficient area for a flow rate according to present standards, discussed below, while allowing the modular relief valve 50 to fit within the available valve assembly cavities 20.

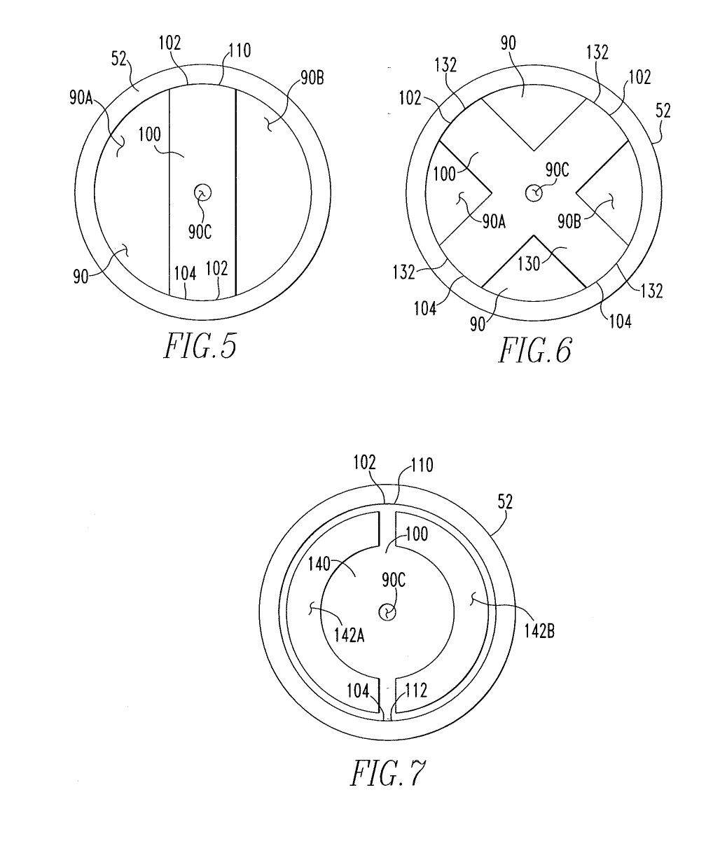

Other configurations of relief valve exhaust passages may also provide the requisite area as well. For example, as shown in FIG. 6, the retainer body 100 may be a planar X-shaped body 130 having four tips 132. In this embodiment, the radial sides of the tips 132 are the arcuate first perimeter portion 102 and second perimeter portion 104 structured to engage the relief valve body second end interior threads 80. As shown in FIG. 7, the retainer body 100 is a circular disk 140 having two opposing arcuate openings 142A, 142B. The arcuate openings 142A, 142B extend substantially, but not entirely, over 180 degrees. The lateral sides 102, 104 of the portions of the circular disk 140 between the arcuate openings 142A, 142B may be threaded and structured to engage the relief valve body second end interior threads 80. That is, the lateral sides of the portions of the circular disk 140 between the arcuate openings 142A, 142B are the arcuate first perimeter portion 102 and second perimeter portion 104.

As a specific example, a cylinder may be structured to store a gas at a pressure of between about 0 and 240 psi., and another cylinder may be structured to store gas at a pressure of between 0 and 260 psi. The service valve 10 for such a cylinder has a relief valve cavity 22 with a radius of between about 0.390 and 0.420 inch, and more typically 0.405 inch. The relief pressure for the modular relief valve 50 is between about 440 and 450 psi., and more preferably about 445 psi to achieve a flow rate of at least 364 scfm (Standard cubic feet per minute) at 480 psi and 394 scfm at 520 psi. The total exhaust passage 90 preferably has an area of between about 258 and 0.279 in.², and more preferably 0.269 in.²

The modular relief valve body 52 has a thickness of between about 0.061 and 0.080 inch, and more typically 0.072 inch. The inner radius at the relief valve body second end 62 is between about 0.379 and 0.385 inch, and more typically 0.382 inch. Thus, the area of the modular relief valve body second end 62 is between about 0.451 and 0.465 in.², and more typically 0.458 in.² The size of the retainer body opening 120 is between about 0.019 and 0.022 in.², and more typically 0.0205 in.² The retainer body 100 has a width, between the parallel sides 106, 108, of between about 0.270 and 0.280 inch, and more typically 0.275 inch. Thus, when the retainer body 100 is disposed within the modular relief valve body second end 62, the exhaust passages 90A, 90B defined by the gap between the retainer body 100 and the modular relief valve body second end 62, each have an area of between about 0.119 and 0.129 in.², and more typically 0.124 in.². Thus, the total area of the exhaust passages 90A, 90B, 90C is between about 0.258 and 0.279 in.², and more typically 0.269 in.²

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A retainer for a relief valve, said relief valve having a hollow, generally cylindrical body having a first end, a second end, an outer surface and an inner surface, said relief valve body defining a relief valve body cavity, said relief valve body second end having interior threads, said retainer comprising:
a generally planar body with a first perimeter portion and a second perimeter portion; and
said first and second perimeter portions being arcuate and each having a threaded radial surface, said first and second perimeter portion radial surfaces structured to engage said relief valve body second end interior threads; and
said retainer body structured to be disposed in said relief valve body cavity second end and to define at least two relief valve exhaust passages through said relief valve body cavity second end when so disposed.

2. The retainer of claim 1 wherein said at least two exhaust passages includes a medial opening in said retainer body and a relief valve exhaust passage defined by a gap between said retainer body and said relief valve body cavity second end.

3. The retainer of claim 2 wherein said retainer body has two opposing parallel sides and two opposing threaded radial surfaces, said threaded radial surfaces being said first and second perimeter portions.

4. The retainer of claim 3 wherein:
said retainer body is elongated and has a longitudinal axis; and
said two opposing parallel sides are elongated and parallel to the longitudinal axis of said retainer body.

5. The retainer of claim 1 wherein:
said retainer body is a circular disk; and
said at least two relief valve exhaust passages include two opposing arcuate openings through said retainer body.

6. A modular relief valve structured to be disposed in a cavity, said cavity being a cylindrical cavity, said cavity having a first end with an opening in fluid communication with a fluid passage, and a second end open to the atmosphere, and a threaded interior surface, said relief valve comprising:
a hollow, generally cylindrical body having a first end, a second end, an outer surface and an inner surface, said body defining a body cavity;
said outer surface having threads thereon, said relief valve body outer threads structured to engage said cavity threaded interior surface;
said relief valve body first end having an inwardly extending flange with a central opening, said flange defining a valve seat;
said relief valve body second end having interior threads;
a valve member, said valve member structured to be movably disposed in said body cavity and to sealingly engage said body first end flange valve seat;
a biasing device, said biasing device structured to engage said relief valve valve member and bias said relief valve valve member against said relief valve valve seat;
a retainer having a generally planar body with a first perimeter portion and a second perimeter portion;
said retainer body first and second perimeter portions being arcuate and each having a threaded radial surface, said first and second perimeter portion radial surfaces structured to engage said relief valve body second end interior threads;
said retainer body structured to be disposed in said relief valve body cavity second end and to define at least two relief valve exhaust passages through said relief valve body cavity second end when so disposed;
said retaining member disposed in said relief valve body second end;
said relief valve valve member movably disposed in said relief valve body cavity; and
said biasing device coupled to, and extending between; said retaining member body and said relief valve valve member.

7. The relief valve of claim 6 wherein said at least relief valve two exhaust passages includes a medial opening in said retainer body and a relief valve exhaust passage defined by a gap between said retainer body and said relief valve body cavity second end.

8. The relief valve of claim 7 wherein said retainer body has two opposing parallel sides and two opposing threaded radial surfaces, said threaded radial surfaces being said first and second perimeter portions.

9. The relief valve of claim 8 wherein:
said retainer body is elongated and has a longitudinal axis; and
said two opposing parallel sides are elongated and parallel to the longitudinal axis of said retainer body.

10. The relief valve of claim 6 wherein:
said retainer body is circular and has a perimeter; and
said at least two relief valve exhaust passages include two opposing arcuate openings through said retainer body.

11. A modular relief valve for a service valve, said service valve having a body and a valve assembly, said service valve body defining a primary fluid passage with a valve seat about said primary fluid passage, a primary exhaust passage, a valve assembly cavity, and a relief valve cavity, said primary fluid passage and said primary exhaust passage being in fluid communication via said valve assembly cavity, said valve assembly disposed in said valve assembly cavity, said valve assembly having a valve member structured to move between two positions, a first, closed position, wherein said valve member sealingly engages said valve seat preventing fluid from passing past said valve member, and a second, open position, wherein said valve member is spaced from said valve seat allowing fluid communication between said primary fluid passage and said exhaust passage, said relief valve cavity being a cylindrical cavity, said relief valve cavity having a first end with an opening in fluid communication with said primary fluid passage and a second end open to the atmosphere, said relief valve cavity having a threaded interior surface, said relief valve comprising:
a hollow, generally cylindrical body having a first end, a second end, an outer surface and an inner surface, said relief valve body defining a relief valve body cavity;
said relief valve body outer surface having threads thereon, said relief valve body outer threads structured to engage said cavity threaded interior surface;
said relief valve body first end having an inwardly extending flange with a central opening, said flange defining a valve seat;
said relief valve body second end having interior threads;
a relief valve valve member, said relief valve valve member structured to be movably disposed in said relief valve body cavity and to sealingly engage said relief valve body first end flange valve seat;
a biasing device, said biasing device structured to engage said relief valve valve member and bias said relief valve valve member against said valve seat;
a retainer having a generally planar body with a first perimeter portion and a second perimeter portion;
said retainer body first and second perimeter portions being arcuate and each having a threaded radial surface, said first and second perimeter portion radial surfaces structured to engage said relief valve body second end interior threads;
said retainer body structured to be disposed in said relief valve body cavity second end and to define at least two relief valve exhaust passages through said relief valve body cavity second end when so disposed;
said retaining member disposed in said relief valve body second end;
said relief valve valve member movably disposed in said relief valve body cavity; and
said biasing device coupled to, and extending between, said retaining member body and said relief valve valve member.

12. The relief valve for a service valve of claim 11 wherein said at least two relief valve exhaust passages includes a medial opening in said retainer body and a passage defined by a gap between said retainer body and said relief valve body cavity second end.

13. The relief valve for a service valve of claim 12 wherein said retainer body has two opposing parallel sides and two opposing threaded radial surfaces, said threaded radial surfaces being said first and second perimeter portions.

14. A service valve comprising:
a body and a valve assembly;
said service valve body defining a primary fluid passage with a valve seat about said primary fluid passage, a primary exhaust passage, a valve assembly cavity, and a relief valve cavity, said primary fluid passage and said primary exhaust passage being in fluid communication via said valve assembly cavity;
said valve assembly disposed in said valve assembly cavity, said valve assembly having a valve member structured to move between two positions, a first, closed position, wherein said valve member sealingly engages said valve seat preventing fluid from passing past said valve member, and a second, open position, wherein said valve member is spaced from said valve seat allowing fluid communication between said primary fluid passage and said exhaust passage;
said relief valve cavity being a cylindrical cavity, said relief valve cavity having a first end with an opening in fluid communication with said primary fluid passage and a second end open to the atmosphere, said relief valve cavity having a threaded interior surface; and
a modular relief valve including a body, a valve member, a biasing device, and a retainer;
said relief valve body being a hollow, generally cylindrical body having a first end, a second end, an outer surface and an inner surface, said relief valve body defining a relief valve body cavity;
said relief valve body outer surface having threads thereon, said relief valve body outer threads structured to engage said relief valve body cavity threaded interior surface;
said relief valve body first end having an inwardly extending flange with a central opening, said flange defining a valve seat;
said relief valve body second end having interior threads;
said relief valve valve member structured to be movably disposed in said relief valve body cavity and to sealingly engage said relief valve body first end valve seat;
said relief valve biasing device structured to engage said relief valve valve member and bias said relief valve valve member against said relief valve valve seat;
said retainer having a generally planar body with a first perimeter portion and a second perimeter portion;
said retainer body first and second perimeter portions being arcuate and each having a threaded radial surface, said first and second perimeter portion radial surfaces structured to engage said relief valve body second end interior threads;
said retainer body structured to be disposed in said relief valve body cavity second end and to define at least two relief valve exhaust passages through said relief valve body cavity second end when so disposed;
said retaining member disposed in said relief valve body second end;
said relief valve valve member movably disposed in said relief valve body cavity;
said biasing device coupled to, and extending between, said retaining member body and said relief valve valve member; and
said relief valve disposed in said relief valve cavity.

15. The service valve of claim 14 wherein said at least two relief valve exhaust passages includes a medial opening in said retainer body and a relief valve exhaust passage defined by a gap between said retainer body and said relief valve body cavity second end.

16. The service valve of claim 15 wherein said retainer body has two opposing parallel sides and two opposing threaded radial surfaces, said threaded radial surfaces being said first and second perimeter portions.

17. The service valve of claim 16 wherein:
said retainer body is elongated and has a longitudinal axis; and
said two opposing parallel sides are elongated and parallel to the longitudinal axis of said retainer body.

18. The service valve of claim 14 wherein:
said retainer body is circular and has a perimeter; and
said at least two relief valve exhaust passages include two opposing arcuate openings through said retainer body.
